(19) United States
(12) Patent Application Publication
(10) Pub. No.: US 2015/0077440 A1
(43) Pub. Date: Mar. 19, 2015

(54) METHOD AND SYSTEM FOR PREVENTING REFLECTION OF LIGHT ON DISPLAY DEVICE

(71) Applicant: Hyundai Motor Company, Seoul (KR)

(72) Inventor: Jong Bok Lee, Suwon-Si (KR)

(73) Assignee: HYUNDAI MOTOR COMPANY, Seoul (KR)

(21) Appl. No.: 14/143,809

(22) Filed: Dec. 30, 2013

(30) Foreign Application Priority Data
Sep. 13, 2013 (KR) 10-2013-0110669

(51) Int. Cl. G09G 3/02; G09G 3/20

(52) U.S. Cl. CPC G09G 3/02; G09G 3/2003; G09G 2340/06; G09G 2320/0666
USPC 345/690

(57) ABSTRACT

A method and a system for preventing reflection of light on a display device are provided. The system includes a light reflection detector that is configured to detect a region in which light reflection is generated by external light interference on a screen of the display device. A light reflection preventing controller is configured to change a color of the detected light reflection region into a light absorbing color when the light reflection region is detected by the light reflection detector to minimize the light reflection on the display device.

### CROSS-REFERENCE TO RELATED APPLICATION

This application claims priority to and the benefit of Korean Patent Application No. 10-2013-0110669 filed in the Korean Intellectual Property Office on Sep. 13, 2013, the entire contents of which are incorporated herein by reference.

### BACKGROUND

(a) Field of the Invention

The present invention relates to a method and a system for preventing reflection of light on a display device, and more particularly, to a method and a system for preventing reflection of light on a display device which detect a region that causes light reflection to change a color of a region of the display device to absorb light of external light interference that causes the light reflection to minimize the light reflection on the display device.

(b) Description of the Related Art

A screen size of a display device mounted within a vehicle has increased over the years. The increase in screen size is advantageous in the view of recognition ability and visibility hut may be a drawback in the view of light reflection. Examples of external light interference which causes the light reflection may include sunlight or a headlight of other vehicles at night. The display device may include a cluster, a display of an audio and video (AV) system, and a display of a navigation system.

In particular, the increase of the screen size of the display device may be a drawback in the view of the light reflection since a region in which the light reflection may be generated is also increased in proportion to the screen size. In other words, as illustrated in FIG. 1, light of the sun S which causes the light refection is reflected from a large area of a display device 10 having a substantially large screen size and may reflect into the eyes 20 of a driver. When the light reflection on the display device 10 is significant, it may influence safe driving.

The above information disclosed in this section is merely for enhancement of understanding of the background of the invention and therefore it may contain information that does not form the prior art that is already known in this country to a person of ordinary skill in the art.

### SUMMARY

The present invention provides a method and a system for preventing reflection of on a display device which detect a region which causes light reflection to change a color of the region of the display device to absorb light of external ht interference which causes the light reflection to minimize the light reflection.

An exemplary embodiment of the present invention provides a light reflection preventing system on a display device that may include a light reflection detector configured to detect a region in which light reflection is venerated by external light interference on a screen of the display device; and a light reflection preventing controller configured to change a color of the detected light reflection region into a color which absorbs light when the light reflection region is detected by the light reflection detector. The detecting of the region which causes the light reflection may be performed using an infrared imaging device (e.g., a camera). The changed color may be a color that absorbs a wavelength of the external light interference which causes the light reflection.

Another exemplary embodiment of the present invention provides a light reflection preventing system on a display device that may include: a light reflection detector configured to detect a region in which light reflection is generated by external light interference on a screen of the display device; and a light reflection preventing controller configured to change a color of the detected light reflection region into a color which absorbs light when the light reflection region is detected by the light reflection detector. The light reflection detector may be an infrared imaging device.

The system may further include an external light interference wavelength analyzer configured to analyze a wavelength of the external light interference which causes the light reflection to provide a wavelength analysis signal to the light reflection preventing controller to change the changed color into a color which absorbs the wavelength of the external light interference.

As described above, according to an exemplary embodiment of the present invention, a region which causes light reflection may be detected to change a color of the region of the display device to absorb light of external light interference which causes the light reflection to minimize the light reflection on the display device.

### BRIEF DESCRIPTION OF THE DRAWINGS

FIG. 1 is an exemplary diagram illustrating a shape of light reflection on a display device by external light interference (sunlight) accordingly to the related art;

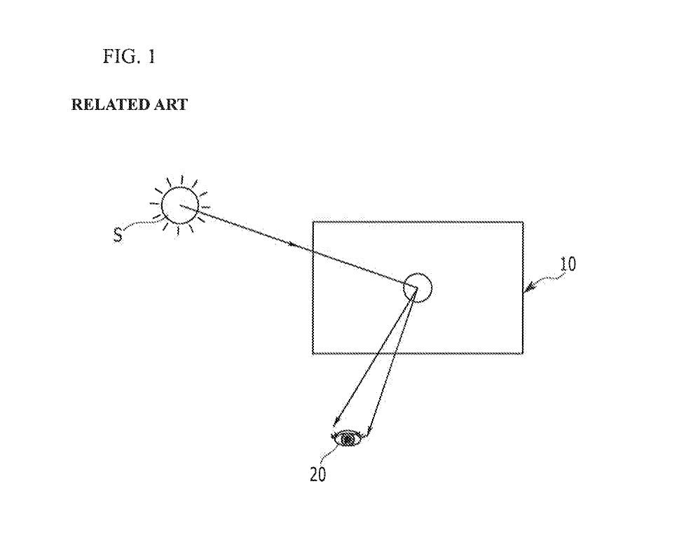

FIG. 2 is an exemplary schematic diagram of a light reflection preventing system on a display device according to an exemplary embodiment of the present invention;

FIG. 3 is an exemplary flowchart of a light reflection preventing method on a display device according to an exemplary embodiment of the present invention;

FIG. 4 is an exemplary diagram illustrating a process of preventing light reflection on a size of a display device according to an exemplary embodiment of the present invention; and

FIG. 5 is an exemplary diagram illustrating a light reflection region which is captured by an infrared imaging device according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is tor the purpose f describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the e art would realize, the described embodiments may be modified in various different ways, all without departing from the spirit or scope of the present invention. Like reference numerals designate like elements throughout the specification.

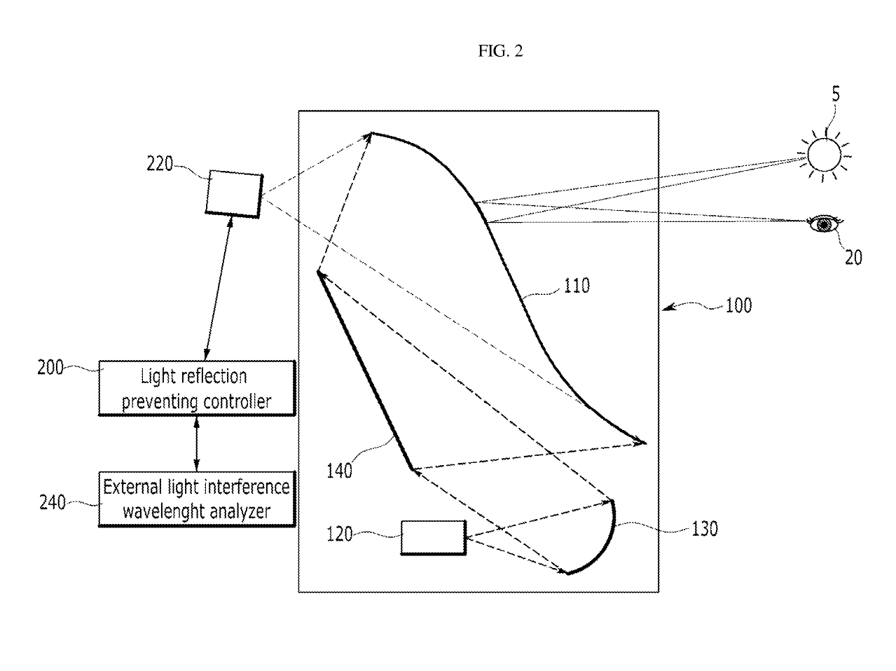

FIG. 2 is an exemplary schematic diagram schematically illustrating a light reflection preventing system on a display device according to an exemplary embodiment of the present invention. A light reflection preventing system on a display device according to an exemplary embodiment of the present invention may be a system that efficiently prevents light reflection generated on the display device due to external light interference.

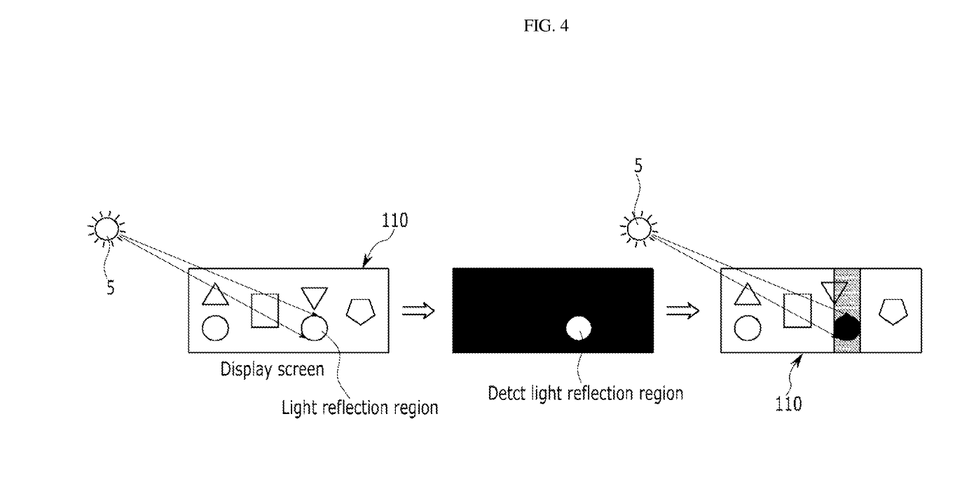

The light reflection preventing system on a display device according to the exemplary embodiment of the present invention may include a light reflection detector 220 configured to detect a region (see FIG. 4) in which light is reflected due to external light interference, on a screen 110 of the display device 100, a light reflection preventing controller 200 configured to change a color of the detected light reflection region into a color that absorbs light when a light reflection region is detected by the light reflection detector 220, and an external light interference wavelength analyzer 240 configured to analyze a wavelength of the external light interference which causes the light reflection to provide a wavelength analysis signal to the light reflection preventing controller 200 to change the changed color into a color which absorbs the wavelength of the external light interference.

The display device 100 illustrated in FIG. 2 may be a display device mounted within a vehicle and the screen 110 of the display device 100 may be a curved touch screen. Referring to FIG. 2, the display device 100 may include the curved touch screen 110, a projector 120, an aspheric reflection mirror 130, and a reflection mirror 140. The projector 120 may include an illumination (e.g., a light source) and may be configured to output graphic information. The display device 100 described herein is obvious to a person of ordinary skill in the art and thus the detailed description thereof will be omitted.

The light reflection detector 220 may be made of an infrared imaging device (e.g., a camera, video camera, etc.) in the exemplary embodiment of the present invention, but it should be understood that the scope of the present invention is not always limited thereto. Even though the light reflection detector 220 may have a different configuration, if a configuration substantially detects the light reflection region, a technical spirit of the present invention may be applied thereto. The infrared imaging device as the light reflection detector 2200 may use an infrared imaging device which has been used in the related art and thus the detailed description thereof will be omitted.

The light reflection preventing controller 200 and/or the external light interference wavelength analyzer 240 may be at least one microprocessor executed by a predetermined program and/or hardware which includes the microprocessor. The predetermined program may be formed of a series of commands which perform the light reflection preventing method on a display device according to the exemplary embodiment of the present invention, which will be described below. The light reflection preventing controller 200 may include the external light interference wavelength analyzer 240. Alternatively, the external light interference wavelength analyzer 240 may include the light reflection preventing controller 200.

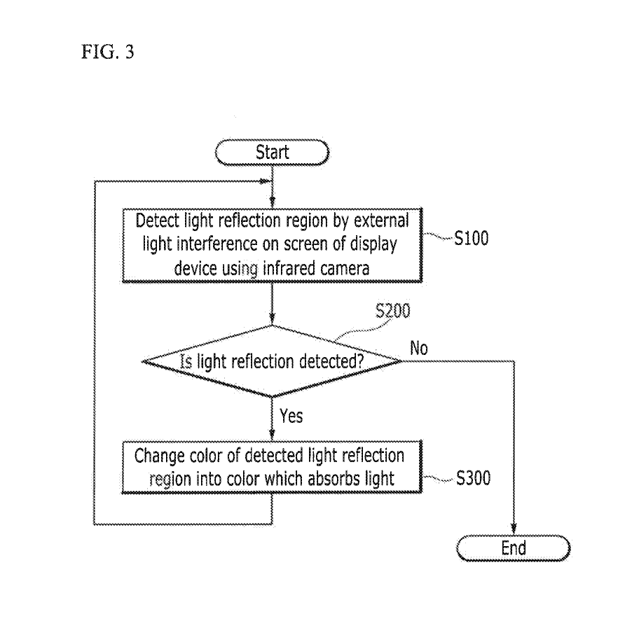

Hereinafter, the light reflection preventing method on a display device according to the exemplary embodiment of the present invention will be described in detail with reference to accompanying drawings. FIG. 3 is an exemplary flowchart of a light reflection preventing method on a display device according to an exemplary embodiment of the present invention.

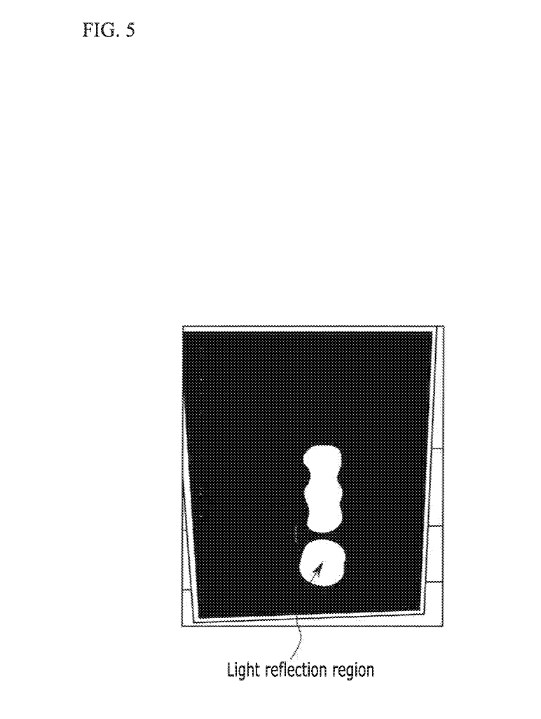

As illustrated in FIG. 3, when the display device 100 is operating, the light reflection preventing controller 200 may be configured to operate the infrared imaging device 220 to allow the infrared imaging device 220 to detect whether there is light reflection caused by the external light interference on the screen 110 of the display device 100 in step S100. When there is light reflection on the screen 110, as illustrated in FIGS. 4 and 5, the infrared imaging device 220 may be configured to capture the light reflection region with a white color and the remaining region with a black color to detect the light reflection region more easily. In other words, a region represented by a white circle in FIG. 5 is the light reflection region which may be captured by the infrared imaging device.

When the light reflection region is detected by the infrared imaging device 220 in step S100, the external light interference wavelength analyzer 240 may be configured to analyze a wavelength of the external light interference 5 that causes the light reflection on the screen 110 of the display device 100 in step S200. When the wavelength of the external light interference 5 is analyzed by the external light interference wavelength analyzer 240, the light reflection preventing controller 200 may be configured to change a color of the detected light reflection region into a color that absorbs analyzed wavelengths of the external light interference in step S300. The light reflection preventing controller 200 may be configured to change the color of the detected light reflection region into a black-series color which is known as a color that generally absorbs the light, regardless of the analyzed wavelength of the external light interference.

Moreover, the light reflection preventing controller 200 may be configured to change the color in the detected light reflection region and in substantially the entire width region of the detected light reflection region as illustrated in FIG. 4. Therefore, according to the exemplary embodiment of the present invention, a region that causes light reflection may be detected to change a color of the region of the display device to absorb light of external light interference which causes the light reflection to minimize the light reflection on the display device.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

Description of symbols

| | |
|---|---|
| 100: Display device | 110: Screen |
| 200: Light reflection preventing controller | |
| 220: Infrared imaging device | |
| 240: External light interference wavelength analyzer | |

What is claimed is:

1. A light reflection preventing method on a display device, the method comprising:
detecting, by a controller, a region that causes light reflection by external light interference on the display device; and
changing, by the controller, a color of the detected light reflection region into a light absorbing color.

2. The method of claim 1, wherein the detecting of the region that causes the light reflection is performed using an infrared imaging device.

3. The method of claim 1, further comprising:
analyzing, by the controller, a wavelength of the external light interference that causes the light reflection on the screen of the display device.

4. The method of claim 1, wherein the light absorbing color is a color that absorbs a wavelength of the external light interference that causes the light reflection.

5. A light reflection preventing system on a display device, comprising:
a light reflection detector configured to detect a region in which light reflection is generated by external light interference on a screen of the display device; and
a light reflection preventing controller configured to change a color of the detected light reflection region into a light absorbing color when the light reflection region is detected by the light reflection detector.

6. The system of claim 5, wherein the light reflection detector is an infrared imaging device.

7. The system of claim 5, wherein the light reflection preventing controller is further configured to:
analyze a wavelength of the external light interference that causes the light reflection to change the color into a color that absorbs the wavelength of the external light interference.

8. A non-transitory computer readable medium containing program instructions executed by a controller, the computer readable medium comprising:
program instructions that control an imaging device to detect a region in which light reflection is generated by external light interference on a screen of the display device; and
program instructions that change a color of the detected light reflection region into a light absorbing color when the light reflection region is detected by the light reflection detector.

9. The non-transitory computer readable medium of claim 8, further comprising:
program instructions that analyze a wavelength of the external light interference that causes the light reflection to change the color into a color that absorbs the wavelength of the external light interference.
